(19) United States
(12) Patent Application Publication
(10) Pub. No.: US 2018/0260414 A1
(43) Pub. Date: Sep. 13, 2018

(54) QUERY EXPANSION LEARNING WITH RECURRENT NETWORKS

(71) Applicant: Xerox Corporation, Norwalk, CT (US)

(72) Inventor: Albert Gordo Soldevila, Grenoble (FR)

(73) Assignee: Xerox Corporation, Norwalk, CT (US)

(21) Appl. No.: 15/455,672

(22) Filed: Mar. 10, 2017

(51) Int. Cl. G06F 17/30; G06N 3/04

(52) U.S. Cl. CPC G06F 17/30247; G06N 3/0445; G06F 17/30448

(57) ABSTRACT

A method for query expansion uses a representation of an input query object, such as an image, to retrieve representations of similar objects retrieved using the query object representation as a query. Given the set of image representations, a weight is predicted for each using a prediction model which assigns different weights to the image representations. An expanded query is generated as a weighted aggregation (e.g., sum) of the query object representation and at least a subset of the set of similar object representations in which each object representation is weighted with its predicted weight. A higher weight can thus be given to one of the similar object representations, in the expanded query, than to another.

### BACKGROUND

Aspects of the exemplary embodiment relate to expansion of an instance-level query, such as an image representation and finds particular application in connection with a system and method for assigning weights to retrieved images for expanding the query.

Querying by example is a common method for retrieving objects, such as images from a dataset. A query based on a single query image may be expanded by retrieving similar images from a dataset of images that are not annotated. Once the ranked list of results has been produced for a given query, the top K retrieved results are combined into a single, more informed query, and this combined representation is used to search again in the dataset of images. Query expansion techniques are useful in image retrieval, as they can significantly improve the accuracy of the system while not requiring significantly more resources (O. Chum, et al., “Total recall: Automatic query expansion with a generative feature model for object retrieval,” ICCV, pp. 1-8, 2007, hereinafter, Chum 2007).

A common query expansion technique is average query expansion (AQE). In this technique, images are represented with a feature vector and it is assumed that a measure of similarity of the feature vectors correlates with the similarity of the represented images. The vectors may be high-dimensional and sparse, such as Bag-of-Visual Word representations, moderately low dimensional, such as Fisher vectors (see, Sivic, et al., “Video Google: a text retrieval approach to object matching in videos,” ICCV, pp. 1470-1477, 2003), or low-dimensional and dense, e.g., generated by a neural network, such as a convolutional neural network (CNN) (see, for example, Radenovic, et al., “CNN Image Retrieval Learns from BoW: Unsupervised Fine-Tuning with Hard Examples,” ECCV 2016, pp 3-20, 2016 (hereinafter, Radenovic 2016; Albert Gordo, et al., “Deep Image Retrieval: Learning global representations for image search,” ECCV 2016, pp 241-257, 2016, hereinafter, Gordo 2016. These feature-vector-based representations can be compared with standard similarity or distance measures, such as the cosine distance (dot-product), Euclidean distance, intersection kernel, or the like. In that case, AQE simply averages the representation of the top K retrieved results together with the original query to produce the new query vector. Despite its simplicity, a well-tuned AQE can have a good accuracy.

However, there are problems with the AQE method. First, the number of top results K that are used to construct the new representation has to be selected carefully. A low K will not fully leverage the top results and will lead to limited improvements in accuracy. A high K will include irrelevant results that tend to degrade the accuracy instead of improving it. Additionally, K is not only very dataset dependent, but also query dependent, and there is no easy and effective heuristic to choose it. Second, AQE assigns the same weight to all the top results when combining them, independently of how relevant or useful they are.

Another approach is to perform discriminative query expansion (DQE) at test time. In this method, a classifier is learnt (e.g., an SVM or a one-class SVM) using the query and the top results as positive samples and, if applicable, low-ranked random images as negatives. The classifier can then be seen as a new representation of the query and the top images (see, R. Arandjelovic, et al., “Three things everyone should know to improve object retrieval,” CVPR, pp. 2911-2918, 2012). Although this approach can learn more discriminative representations, it tends to be very sensitive to the optimal choice of K, as all K samples are explicitly labeled as positives and the presence of incorrect results in the top K images can severely affect the model. This form of DQE also requires learning a new model at test time for every new query, which is undesirable.

Given the potentially large improvements in accuracy that query expansion can bring in retrieval tasks, a form of query expansion that still leads to improvements in accuracy but does not have the problems of AQE or DQE at test time is sought.

### INCORPORATION BY REFERENCE

The following reference, the disclosure of which is incorporated herein by reference, is mentioned:

U.S. application Ser. No. 15/455,551, filed contemporaneously herewith, entitled INSTANCE-LEVEL IMAGE RETRIEVAL WITH A REGION PROPOSAL NETWORK, by Albert Gordo Soldevila, et al., hereinafter, Gordo Soldevila 2017.

### BRIEF DESCRIPTION

In accordance with one aspect of the exemplary embodiment, a method for query expansion includes receiving a query object representation and a set of representations of similar objects retrieved using the query object representation as a query. Weights for the query object representation and the set of similar object representations are predicted with a prediction model. An expanded query is generated as a weighted aggregation of the query object representation and at least a plurality of the set of similar object representations. In the aggregation, the query object representation and the least a plurality of the set of similar object representations are each weighted with a respective one of the predicted weights.

One or more of the steps of the method may be implemented with a processor.

In accordance with another aspect of the exemplary embodiment, a system for query expansion includes memory which stores a weights prediction model. A representation generator generates a representation of an input query object. A querying component retrieves a first set of representations of similar objects to the query object using the query object representation as a query. A query expansion component predicts weights for the query object representation and the set of similar object representations with the weights prediction model and generates an expanded query as a weighted aggregation of the query object representation and at least a plurality of the set of similar object representations. In the aggregation, the query object representation and the similar object representations are each weighted with a respective one of the predicted weights. The querying component is configured for retrieving a second set of representations of similar objects using the expanded query.

In accordance with another aspect of the exemplary embodiment, a method for generating a prediction model for predicting weights for generating an expanded query includes providing an annotated set of training image representations. For a plurality of iterations the method includes: selecting one of the training image representations as a query image representation, retrieving a set of similar image representations from the set of training image representations based on the query image representation, inputting the query image representation and set of similar image representations into a prediction model to be learned, generating a context-based representation for each of the query image representation and set of similar image representations with a neural network of the prediction model, with current parameters of a fully-connected layer of the prediction model, converting each of the context-based representations to a respective weight, generating an expanded query as a sum of the query image representation and similar image representations, each weighted by a respective one of the weights, computing a loss with a loss function based on the expanded query and representations of first and second training image representations and their respective annotations, and updating parameters of the prediction model based on the computed loss, the updating including updating the current parameters of the fully-connected layer. The prediction model with updated parameters from one of the plurality of iterations is output.

One or more of the steps of the method may be performed with a processor.

### BRIEF DESCRIPTION OF THE DRAWINGS

FIG. 1 is a functional block diagram of a query expansion system in accordance with one aspect of the exemplary embodiment;

FIG. 2 is a flow chart illustrating a method of query expansion in accordance with another aspect of the exemplary embodiment;

FIG. 3 illustrates training of a weight prediction model in accordance with one aspect of the exemplary embodiment;

FIG. 4 illustrates an example LSTM cell;

FIG. 5 is a flow chart illustrating learning of a prediction model in the method of FIG. 2;

FIG. 6 illustrates two queries together with their first four retrieved results;

FIG. 7 is a graph showing performance of the exemplary system on a first dataset in comparison to other methods as a function of the number of top results K used in query expansion; and

FIG. 8 is a graph showing performance of the exemplary system on a second dataset in comparison to other methods as a function of the number of top results K used in query expansion.

### DETAILED DESCRIPTION

Aspects of the exemplary embodiment relate to a system and method for query expansion and retrieval. The exemplary embodiment is particularly suited to retrieval of images, however, other objects capable of being represented with a multidimensional representation are also contemplated, such as video recordings, audio recordings, text documents, and the like. In the following the focus is on image retrieval bearing in mind that such other representable objects are also contemplated.

Briefly, starting with a representation of an initial image (“query image”) a first set of K similar images is retrieved in a first query. A weights prediction model predicts weights for the representations of the similar images. A weighted aggregation of the representations defines a second query that can be used to retrieve a second set of similar images. The weights prediction model may be a deep model based on a recurrent neural network that learns how to perform query expansion in a discriminative manner. In particular, given the ranked list of K top images and the query, the model predicts the optimal weighting of the representations of those images so that when they are aggregated using those weights, the resulting representation is more discriminative than if they had been averaged (AQE). An advantage of the system and method is that the parameters of the prediction model can be learned offline using an external dataset. This avoids the need to learn a prediction model at test time for every single query. Moreover, contrary to other approaches, the model does not assume that all K results are correct.

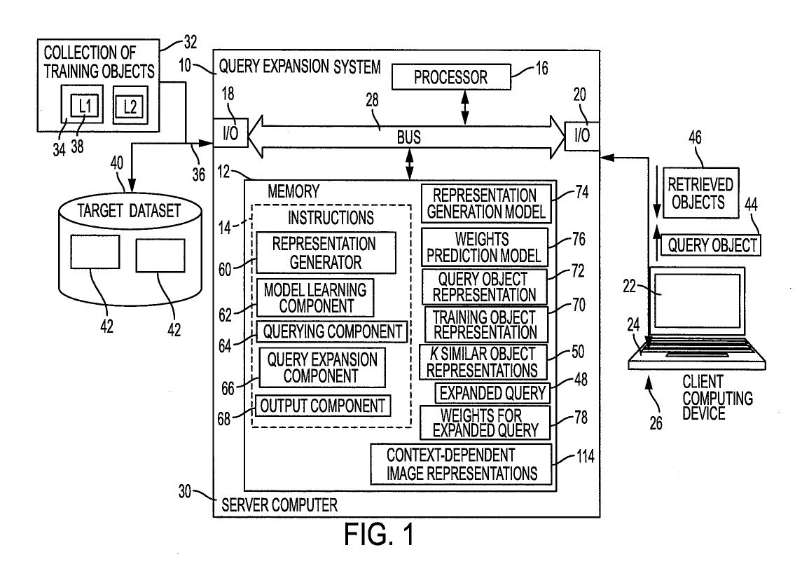

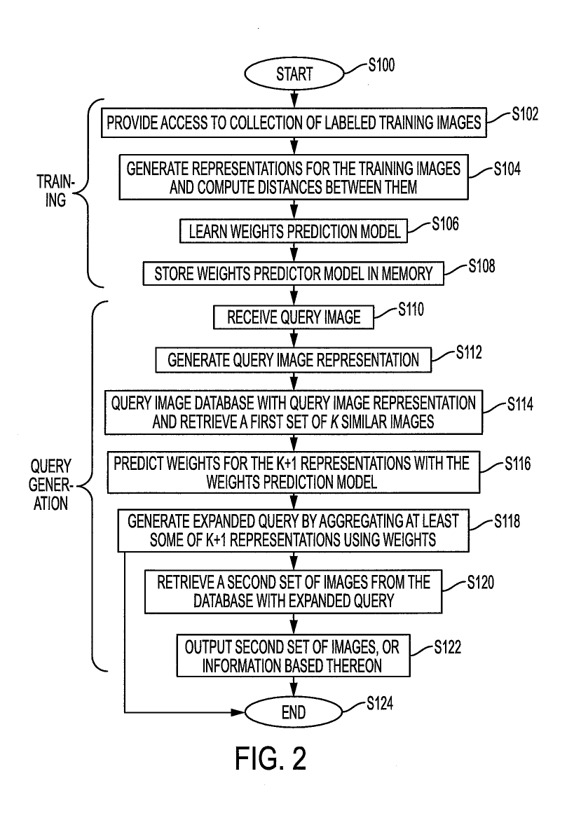

With reference to FIG. 1, a functional block diagram of a computer-implemented system 10 for prediction model generation and query expansion is shown. The illustrated computer system 10 includes memory 12 which stores software instructions 14 for performing the method illustrated in FIG. 2 and a processor 16 in communication with the memory for executing the instructions. The system 10 also includes one or more input/output (I/O) devices, such as a network interface 18 and/or a user input output interface 20. The I/O interface 20 may communicate with one or more of a display 22, for displaying information to users, speakers, and a user input device 24, such as a keyboard or touch or writable screen, and/or a cursor control device, such as mouse, trackball, or the like, for inputting text/selection of a query image and for communicating user input information and command selections to the processor device 16. These components may be directly linked to the system or be part of a client device 26 that is wired or wirelessly linked to the system 10. The various hardware components 12, 16, 18, 20 of the system 10 may all be connected by a data/control bus 28.

The computer system 10 may include one or more computing devices 30, such as a PC, such as a desktop, a laptop, palmtop computer, portable digital assistant (PDA), server computer, cellular telephone, tablet computer, pager, combination thereof, or other computing device capable of executing instructions for performing the exemplary method.

The system 10 has access to a collection 32 (large set) of annotated training objects 34, such as photographic images or other digital images. The collection may be stored in memory 12 or accessed from a remote memory, e.g., via a wired or wireless link 36, such as a wide area network or a local area network, such as the Internet. The training images 34 in the collection 32 are each labeled with a respective annotation 38, such as one or more object class labels e.g., in the form of meta-data, such that the images 34 can be grouped based on the visual object that they contain, such as a particular building, e.g., the Eiffel Tower, in Paris, or the Landscape Arch, in the Grand Canyon. In another embodiment, the labels may refer to a group of visual objects that are similar in appearance, such as metal lattice towers, or natural stone arches.

The illustrated system 10 also has access to a target dataset 40 of objects 42, such as images, e.g., photographic or other digital images, which need not be labeled. In some embodiments, the dataset 40 may be the same the collection 32 or incorporate at least a part of the collection 32. In other embodiments, there may be no overlap between datasets 32, 40. The dataset 40 may be stored in memory 12 or accessed from a remote memory, e.g., via the wired or wireless link 36. The system 10 receives, as input, a query object 44, such as a query image (or a multidimensional representation thereof), and outputs a set of retrieved objects 46, from the dataset 40, that are responsive to an expanded query 48 generated based on multidimensional representations 50 of a set of K similar objects retrieved from the target dataset 40 (or a separate dataset). K may be at least 2 or at least 5, but need not be a number that is fixed in advance. For example, K could be the number of images which meet a threshold similarity, up to a predefined maximum number.

The exemplary instructions 14 include a representation generator 60, a model learning component 62, a querying component 64, a query expansion component 66, and an output component 68.

The representation generator 60 generates representations 70, 50, 72 for the training images 34, database images 42, and query image 44, respectively, if these are not otherwise provided. Each image representation 70, 50, 72 is a fixed dimension, multidimensional vectorial representation of pixels of the respective image from which it is generated. Any suitable type of representation can be used which allows a similarity measure to be computed between image representations, such as the cosine distance (dot-product), Euclidean distance, intersection kernel, or the like. In one embodiment described herein, the image representations are generated with a representation generation model 74, such as a convolutional neural network (CNN) model.

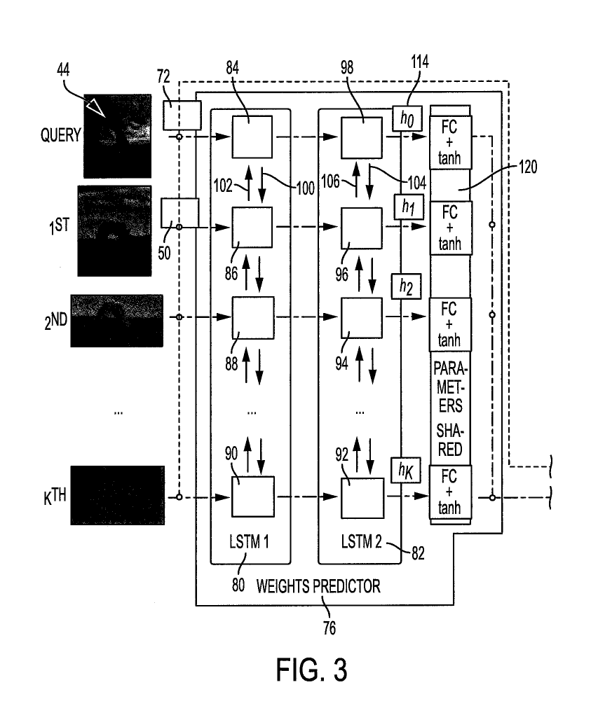

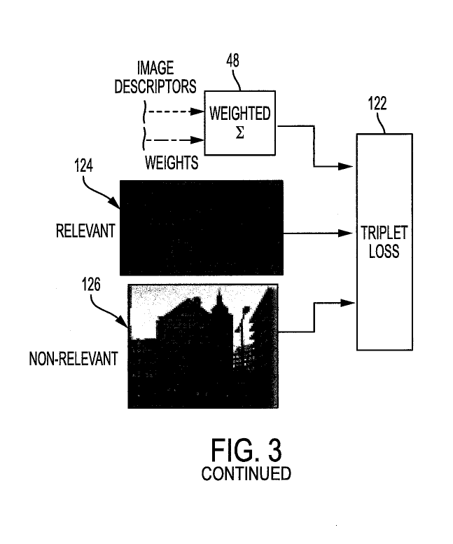

The model learning component 62 learns a weights prediction model 76, such as a neural network-based model, which is configured to receive as input the representations 72, 50 of the query image and similar images and output a set of weights 78 for use in aggregating the image representations 72, 50 (or at least a subset of them) to form the expanded query 48. Further details of an exemplary prediction model 76 are given below, with respect to FIGS. 3 and 4.

The querying component 64 queries the target dataset 40 with queries, such as an initial query, based on the query object representation 72, or an expanded query 48, based on the weighted similar object representations, and retrieves a set of responsive images from the target dataset. The querying component 64 may perform similar functions using the training collection 32 during training of the weights prediction model 76.

The query expansion component 66 inputs the set of image representations 72, 50 into the weights prediction model 76 and aggregates the image representations using the weights generated by the model 76 to generate the expanded query 48.

The output component 68 outputs images 46 retrieved from the dataset 40 in response to the expanded query 48, or information based thereon.

As will be appreciated, the training of the model 76 and the generation of an expanded query 48, using the model 76 may be performed with separate computing devices, but for ease of illustration, all of the components are shown on a single computing device.

There are several advantages to the exemplary model learning-based approach.

1. The weights prediction model 76 can be learned offline, i.e., prior to receiving the query image 44. Compared to other discriminative query expansion methods, this means that no costly learning is required at test time.

2. The model 76 does not assume that all the top K results are positive samples, an assumption that both AQE (implicitly) and other DQE methods (explicitly) make. Instead, the model 76 learns how to aggregate the image representations to optimize directly a ranking metric. This contributes to the robustness of the method.

3. The model 76 learns the optimal parameters in a discriminative manner. Compared to AQE, the two main advantages of this are:
a) Ability to up-weight and down-weight images based on their context, instead of assigning the same weight to all of them.
b) Choosing the optimal K is no longer a critical aspect. A large range of values of K can lead to excellent results.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18, 20 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference to FIG. 2, a computer-implemented method for learning a weight prediction model and using the model to generate an expanded query, which may be performed with the system of FIG. 1, is shown. The method begins at S100.

At S102, access is provided to a collection 32 of annotated training images 34.

At S104, image representations 70 are generated for the training images 32, by the representation generator 60, e.g., using the representation generator model 74, or other function.

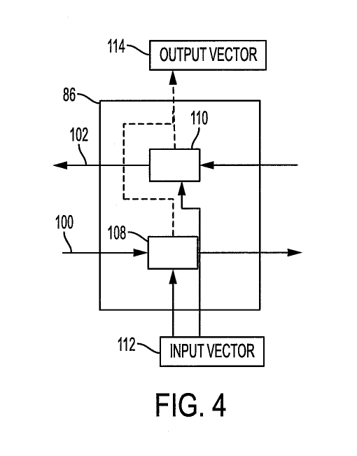

At S106, the weights prediction model 76 is learned, by the model learning component 62. Further details of this step are described below with reference to FIG. 5.

At S108, the weights prediction model 76 is stored in memory of the computer 30, or a different computing device. This ends the training stage.

At S110, a query image 44 is received, which is to be used to generate an expanded query. The query image 44 (or its image representation 72) may be received as input by the system interface 20, e.g., from the client device 26.

At S112, a query image representation 72 is generated (if not already done), by the representation generator 60, e.g., using the representation generator model 74, in the same manner as for the training images 34. In some embodiments, for providing security to a client, the system may receive the query image representation 72 from the client device 26, rather than the query image 44.

At S114, the query image representation 72 is used, by the querying component, to query the target dataset 40 and retrieve a first set of K similar images (based on the similarity of their representations 50). The K similar images are ranked in order of their distance from the query image representation (the most similar images being placed higher in the ranking than less similar images).

At S116, the weights prediction model 76 is used to assign weights 78 to the image representations 72, 50, by the query expansion component 66, in a similar manner to that used in the training of the prediction model 76.

At S118, an expanded query 48 is generated, in the form of a multidimensional vector, by the query expansion component 66, using the weights 78 generated at S116 and the image representations of the query image 72 and at least some of the K retrieved images.

At S120, the expanded query 48 may be used to retrieve a second set 46 of images from the database 42, based on the similarity of their representations, by the querying component 64.

At S122, the second set 46 of retrieved images (and/or their representations) may be output, and/or information may be generated therefrom. In some embodiments, the representations of the second set 46 of images may be used to generate a further expanded query by repeating S116, S118. In other embodiments, the system 10 may output the expanded query 48, rather than the query results 46, so that the client can query the same dataset 40 or a private dataset. In some embodiments, the output information may include information generated based on the second set of images, such as a label for the input image 44 (based on annotations for the retrieved images), a region of interest for the query image (based on regions of interest for the retrieved images), or the like.

The method ends at S124.

Further details of the system and method will now be described.

Let [symbol] denote an image, such as image 34 or 42, and ϕ denote a function (employed by representation generator 60) that encodes a single image into a real-valued d-dimensional space, i.e., ϕ( [symbol] ) ∈ [symbol] ^{d}, and where the distance/similarity between the image encodings (image representations) is consistent with the distance/similarity between the original images. The exact form of the embedding function ϕ is not critical, and can range from a bag of visual words encoding to more complex deep-learning-based techniques, such as the exemplary convolutional neural network (CNN)-based model 74.

Let [symbol] ₁, [symbol] ₂, . . . , [symbol] _{K} denote the K nearest images to [symbol] in a dataset 40. Then, the goal of query expansion is to produce an aggregated representation 48, denoted qₐ=θ( [symbol] , [symbol] ₁, [symbol] ₂, . . . , I_{K}), qₐ ∈ [symbol] ^{d}, that combines the top images into a single representation that will hopefully be more informative than any of the individual images.

One suitable θ function which may be employed is of the form θ( [symbol] , [symbol] ₁, [symbol] ₂, . . . I_{K}; α=αϕ( [symbol] )+Σₖ₌₁^{K}αₖϕ( [symbol] _{K}), i.e., the expanded query is a weighted sum of the image representations. AQE is a particular case of this aggregation where

$$α = \frac{1}{K + 1} .$$

A DQE model using a one-class SVM trained at test time is also a particular case, where the weights α correspond to the dual coefficients of the SVM. A two-class SVM can also be used if there is access to negative data, as illustrated in the Examples below.

In the present system and method, when given a query and a ranked list of K images, rather than using fixed weights, the model 76 predicts the optimal weights α to use in the aggregation function θ to create a more discriminative representation, without assuming that all of the images in the ranked list are positive. More details on the architecture of the prediction model 76, and the training procedure to learn the optimal parameters of the model are now described.

### Weights Prediction Model

The main objective of the model 76 is to assign a weight to each of the K+1 individual images. For this task, a naive approach could involve a simple projection and non-linearity, e.g., α=tanh(w^{T}ϕ [symbol] +b): the representation is first embedded into one dimension with w ∈ [symbol] and b ∈ [symbol] , and the final weight is obtained after a hyperbolic tangent (tanh) non-linearity that ensures that the weight α is in the [−1,1] range. T represents the transpose. This function could be applied to all the images in the ranked list to obtain their weights. However, in such an approach, a particular image would always be assigned the same weight. In the present system and method, the weight that each image is assigned depends on how it can complement the query image and the neighboring images.

In the exemplary embodiment, the query representation 72 and those of the top K images are embedded in a different vectorial space of D dimensions, where D can be the same or different from the dimensionality d of the input vectors. This results in the generation of a context-dependent representation of each image in the K+1 set. The embedding takes into consideration not only the representations of the individual images but those of all the K+1 images jointly, and so the embedding of each image is influenced by all its neighbors. Let Θ: { [symbol] [symbol] ₁, . . . , [symbol] ₖ}→ [symbol] ^{Dx(K+1)} denote the function that embeds the K+1 images in a vectorial space where the representation of the images depend on each other. In that case, as the representations contain information about the other images, the embedding can be converted to one dimension, which, with the tanh nonlinearity previously discussed can be used to obtain the final K+1 α weights:

α=tanh(w^{T}Θ( [symbol] , [symbol] ₁, [symbol] ₂, . . . , [symbol] _{K})+b), (1)

where w ∈ [symbol] ^{D} and b ∈ [symbol] regress the weight based on the joint image representation. w is thus a vector having the same number of dimensions D as the context-dependent image embedding generated with function Θ. b is a bias term (scalar value) to be learned along with w during the learning of the model. The product w^{T}Θ is a vector of K+1 scalar values (one per image), which is added to term b and converted to weight a with the non-linear function tanh. Each of the K+1 images is thus assigned a weight in the range [−1,1]. The use of the tanh function generally results in the weight α₀ of the query image being the highest, although this is not necessarily the case, particularly if the query image is not prototypical.

To construct a function Θ that embeds the images, a recurrent neural network (RNN) may be used, such as a stack of one or more bidirectional RNNs, e.g., two, bi-directional Long Short-Term Memory (LSTM) networks. An LSTM can receive a sequence of inputs (in this case, the representations of the image and the top K retrieved results) and produce another sequence of the same length with the embedded representations. A useful property of (uni-directional) LSTMs (and RNNs in general) is that the output of every element in the sequence depends not only on the particular element, but also of all the previous elements in the sequence, i.e., the representation of every image will be conditioned by the previous images in the sequence when using a uni-directional LSTM. In the case of bi-directional LSTMs, each output is conditioned not only by the previous inputs, but also by the inputs ahead of it, obtaining even more context. Furthermore, the use of a stack of two bi-directional LSTM modules allows adding even more context, as every image will be influenced by an already contextualized representation of the neighboring images. The output of the second LSTM module, a vectorial representation of the images, is finally projected into one dimension and transformed with a tanh function to obtain the final α weights, as previously discussed.

With reference now to FIG. 3, an illustrative weights prediction model 76 as described above, incudes a stack of two bi-directional recurrent neural networks (bi-RNNs), such as bi-directional LSTM modules 80, 82. Each bi-RNN 80, 82 is composed of a sequence of recurrent units (cells) 84, 86, 88, . . . , 90, and 92, . . . , 94, 96, 98, respectively, such as Long Short Term Memory (LSTM) or Gated Recurrent Unit (GRU) cells which define forward and backward directions 100, 102, 104, 106. Each cell may be configured as illustrated in FIG. 4, with forward- and backward-direction cell components 108, 110. In the first bi-RNN 80, each component 108, 110 of the cell 86 takes as input 112 a respective image representation of one of the K+1 images and the hidden state output by the preceding cell component (where one exists) along the respective input or output path, and outputs a new hidden state, as a function of the two inputs, to the respective cell component of the following cell along the input or output path, respectively (where this exists). Output hidden states from the cell components 108, 110 are aggregated to generate an output vector 114, which, in the case of cell 86, serves as input 112 to cell 96 and in the case of cells 92, . . . , 94, 96, 98 serves as the context-dependent representation.

The image representations 72, 50 may be input to the model 76 in ranked order, as shown in FIG. 3. Thus, the LSTM cells each receive contextual information from the cells for their most closely-ranked neighbors in the forward and backward directions.

The prediction model 76 includes a fully-connected layer 120 which generates the set of weights 78 for the expanded query, based on the output vectors 114 from the second bi-RNN 82 (or last bi-RNN, if there are fewer or more than two bi-RNNs) denoted by h, which serve as new, context-dependent representations of each of the images. Parameters w,b of layer 120 are learned during training, as well as parameters of the LSTM cells.

In the examples below, each image representation 72, 70, 50 is 512 dimensions. Each of the uni-directional LSTM cells 108, 110 produces an output of 128 dimensions, and the outputs are concatenated to produce a 256-dimensional output vector 114.

A fuller description of LSTMs can be found in Hochreiter, et al., “Long Short-Term Memory,” Neural Computation 9(8): 1735-1780, 1997, and can be implemented with the set of equations described in C. Olah “Understanding LSTM Networks,” 2015, available at http://colah.github.io/posts/2015-08-Understanding-LSTMs/. A feature of LSTMs is that information is passed from one cell to the next (context), but at each cell, some of that information is forgotten, by multiplying the old cell state with a forget function.

This learned approach to query expansion has several benefits. LSTMs are differentiable models, and therefore they can be trained with backpropagation in a discriminative manner. LSTMs are also more powerful and easy to train than other types of RNNs. The use of a stack of two bi-directional LSTMs allows adding more context to the images, which is advantageous to accurate prediction of their relative weights. Further, as LSTMs are sequence models (the cells share the same parameters), there is no need to fix the parameter K. At testing time, the number of images K that are fed to the network can be adjusted without needing to modify the model in any way. It is also noted that the method is not tied to the specific choice of a stack of two bi-directional LSTMs. Other RNNs (such as gated recurrent units (GRUs), other links between the RNN cells (such as uni-directional RNN, tree RNN, or graph RNN, instead of bi-directional), other combinations (one single RNN, or a stack of more than 2 RNNs), or even other architectures different than RNNs that are able to consider context (such as memory networks), could be used.

Training the Weights Prediction Model (S106)

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

For training purposes, access to an annotated dataset of images 32 is provided, where, given a pair of images, it is known if they belong to the same object instance or not. The training dataset 32 can be different from the target dataset 40 used for experiment or deployment. It is also assumed that function ϕ, the function that extracts features from a single image without context (e.g., model 74), is known and fixed (although, in principle, ϕ could be learned simultaneously with the model 76 used in query expansion). During the preprocessing stage (S104), the training object representations for all the training images 34 are extracted with ϕ, using the representation generator 60, their all-to-all distances computed, and, for every image, a ranked list of all the remaining images sorted by similarity is obtained. There is no guarantee that the top ranked images will be relevant or not to the source image.

In training, iteratively, one of the training images 32 is used as a query image together with a set of the K most similar remaining images from the dataset 32. The representations of the query image and its K closest neighbors (i.e., the top-K retrieved results, which may or may not be correct) are fed into the model 76. A new, context-dependent representation (h₀,h₁, . . . , hₖ) 114 of each image, including the query image 44, is output by the last bi-RNN 82. Each new context-dependent representation contains information not only about each image in the set but also about how it relates to the other images. The fully-connected layer 120, which may be followed by a non-linearity, such as a hyperbolic tangent non-linearity, then predicts the weight that each image should be given when aggregated with the others to form the final expanded query 48. The parameters of the fully-connected layer 120 and bi-RNNs 80, 82 are learned using a suitable loss function and are shared across the layer 120. An example of such loss function is a triplet loss 122. The triplet loss 122 is used to modify parameters of the model such that images relevant to the aggregated query 48 (as indicated by their ground truth annotations) are ranked closer than non-relevant images, e.g., the similarity between a relevant image 124 (with label, “natural rock arch”) to the weighted representation 48 should be higher than the similarity between a non-relevant image 126 (with the label, “building”) to the weighted representation 48. The parameters of the LSTMs and the fully-connected layer that predict the optimal weights to use in the aggregation can be learned through backpropagation.

The goal is to enforce that, given a query image 44 and its top K results aggregated into a single representation 48, given another image 124 that is known to be relevant to the query (because of available annotations), and given yet another image 126 that is not-relevant to the query (it lacks an annotation which matches that of the query annotation), the distance between the aggregated representation and the non-relevant image should be larger than the distance between the aggregated representation and the relevant image (plus a margin m, where m may be predefined and have a value greater than 0). More specifically, if qₐ represents the aggregated representation 48, with [symbol] ⁺the relevant image 124, and with [symbol] ⁻the non-relevant image 126, the aim is to minimize the sum of the following large-margin loss over all combinations of qₐ, [symbol] ⁺, and [symbol] ⁻in the training set:

L(qₐ, [symbol] ⁺, [symbol] ⁻)=max(0,m+∥qₐ−ϕ( [symbol] ⁺)∥²−∥qₐ−ϕ( [symbol] ⁻)∥²). (2)

This function computes the squared norm of the distance (e.g., dot product or Euclidean distance) between the aggregated representation and the representation of the relevant (non-relevant) image. If the distance between the two, when added to m, is less than 0, it means that that the relevant image is closer to the aggregated query than to the non-relevant image plus a margin m, i.e., it is correctly ranked, and then a value of 0 is assigned to the loss of that triplet.

An exemplary method for training the model 76 is illustrated in FIG. 5.

At S202, for a training image that will play the role of a query q, retrieve the K nearest neighbors (that are precomputed).

At S204, the model 76 (with a current set of parameters) is used to compute the weights for the aggregated representation qₐ.

At S206 the aggregated representation 48 is computed, e.g., as a sum of the weighted image representations:

$${q}_{a} = {\sum }_{1}^{K + 1} {α}_{k} {q}_{k} \qquad ( 3 )$$

where αₖ represents one of the K+1 weights and qₖ is the vectorial representation 70 of the respective training image computed with ϕ. The product aₖqₖ merely multiplies each element of vector qₖ by the same weight aₖ. The resulting weighted vectors are summed, elementwise to generate the aggregated representation 48.

At S208, a training image 126 is sampled that is relevant to q based on the ground truth annotation 38. In particular, the sampling is performed only from the ones that are ranked close to qₐ, i.e., an “easy” positive.

At S210, a training image 124 is sampled that is not relevant to q based on the ground truth. In particular, the sampling is performed only from the ones that are ranked close to qₐ, i.e., a “hard” negative.

At S212 the loss 122 of that triplet is computed using Equation (2).

At S214, The parameters of the prediction model are updated, based on the computed loss. This includes computing the gradient of the loss and backpropagating it through the network to obtain the gradient of the loss with respect to the parameters of the LSTMs and the fully-connected layer. The parameters of the LSTMs and the fully-connected layer may be updated using stochastic gradient descent (SGD) with momentum. Other variants of SGD, such as RMSProp, Adagrad, or ADAM can also be used. At the start of the model learning process, the parameters of the model (w, b, and LSTM parameters) may be initialized, for example, with random values or using a data-driven approach.

Steps S202-S214 are iteratively repeated until convergence or until a maximum number of iterations or other stopping point is reached (S216). In general, at least 50, or at least 100 iterations are performed during the learning of the prediction model

In practice, instead of updating the parameters the network with every triplet, a mini-batch of, for example 128 triplets, can be used to obtain more stable updates. Finally, although the triplet-based loss is found to work well in practice, other metric learning losses, such as the contrastive loss (that pulls related samples together and pushes non-related samples apart, but does not try to enforce a ranking explicitly) could also be used.

Data Augmentation During Training

LSTMs, as do other neural networks, are known to benefit from large amounts of labeled training data. To improve the training procedure described above, two forms of data augmentation may be used at training time:

1. K sampling. Although LSTMs can accept sequences of different length at test time, if the model has been learned using a specific value of K, it may be biased towards it, and yield a lower accuracy when other values of K are used at test time. To address this problem, at training time, for every triplet, the value of K may be sampled independently from a discrete uniform distribution, e.g., from a range 2 to 20. This forces the model to learn how to aggregate sequences of different lengths.

2. Top results dropping. Instead of taking the top K results for a given query, at training time only, a top result is selected to be aggregated with probability p (e.g., p=0.5). That is, given one query, the retrieval step (S202) iterates through the top results and each is selected only with probability p, otherwise it is dropped. The process stops once K elements have been chosen. Combined with the K sampling approach, this significantly increases the number of aggregated queries qₐ that can be used during training.

### Generating Expanded Query (S116, 118)

At test time, the query image representation 72 and similar object representations 50 are processed by the model 76 in a similar manner to that described for steps S204 and S206 of the training phase. In particular, the representations of the query image and its K closest neighbors (i.e., the top-K retrieved results, which may or may not be correct) are fed into the stack of trained bi-directional LSTMs that produce a new context-dependent representation for each of the images. This new representation contains information not only about each image but also about how it relates to the other images. The fully-connected layer followed by the non-linearity (e.g., hyperbolic tangent) then predicts the weight that each image should be given when aggregated with the others to form the final aggregated representation. Each weight αₖ is thus computed according to Eqn (1) as:

αₖ=tanh(w^{T}hₖ)+b),

and aggregated according to Eqn (3).

The weighting scheme thus results in different weights for the similar image representations, such that a higher weight is given to one of the similar object representations, in the expanded query, than to another.

Some modifications can be made, which may improve results, as follows.

Border Effects and τ-Correction at Test Time

It can be empirically observed that the weights assigned by the model to the last images in the sequence (e.g. the image input to the LSTM cell 90 in FIG. 3), are not as robust as the weights assigned to the remaining images, reducing the overall quality of the representation and therefore the accuracy of the model. This can be attributed to border effects: images in the middle of the sequence have context on both sides, while images at the beginning and at the end of the sequence lack context on one of their sides. However, contrary to the beginning of the sequence, where the images are ranked highest are thus more likely to be positive images with respect to the query image, the end of the sequence may contain very different, non-relevant images that are much harder to model. This behavior can be more pronounced when using low values of K, but can also be observed to some extent for larger values of K.

To compensate for this problem, an approach referred to herein as τ-correction may be used. This ensures that all the images that will be weighted have sufficient context to be accurately modeled. For this, at test time, K+τ images are considered when computing the representations and the weights of the images. However, after that, only the first K weights are kept, and the last τ images are not considered in the final aggregation. This helps to ensure that all the aggregated images are represented with enough context. τ may be, for example, at least 1 or at least 2. The τ correction is only used to remove the most low-ranked image(s). In the particular case of τ=0, this corresponds to the non-corrected model previously described.

### Representation Generation (S104, S112)

An image representation 72, 50 is a statistical representation of the pixels of the image in the form of a multidimensional vector of, for example, at least 50, or at least 100, or at least 1000 dimensions.

Various methods for generating an image representation are contemplated. These include Bag-of-features representations, which can be generated with large vocabularies and inverted files, as described, for example, in Perdoch, et al., “Efficient representation of local geometry for large scale object retrieval,” CVPR, 2009; Radenovic, et al., “Multiple measurements and joint dimensionality reduction for large scale image search with short vectors-extended version,” Intl Conf. on Multimedia Retrieval, 2015. Methods to approximate the matching of the representations better are described in Paulin, et al., “Local convolutional features with unsupervised training for image retrieval,” ICCV, 2015; Jégou, et al., “Improving bag-of-features for large scale image search,” IJCV, 2010. An advantage of these techniques is that spatial verification can be employed to re-rank a short-list of results. Methods that aggregate the representations of local image patches can be employed. Encoding techniques, such as the Fisher Vector (Perronnin, et al., “Fisher kernels on visual vocabularies for image categorization,” CVPR, 2007; Perronnin, et al., “Large-scale image retrieval with compressed Fisher vectors,” CVPR, 2010), or VLAD (Jégou, et al., “Aggregating local descriptors into a compact image representation,” CVPR, 2010) can be combined with compression (Philbin, et al., “Lost in quantization: Improving particular object retrieval in large scale image databases,” CVPR, 2008; Jégou, et al., “Negative evidences and co-occurrences in image retrieval: The benefit of PCA and whitening,” ECCV 2012; Razavian, et al., “A baseline for visual instance retrieval with deep convolutional networks,” Extended Abstract in ICLR Workshop, 2015) to produce global representations that scale to larger databases at the cost of reduced accuracy.

Neural Network models can also be employed. These take the pixel data as input and progressively reduce the dimensionality of the input through a sequence of convolutional layers. Neural networks developed for other purposes, such as image classification, can be employed or adapted to generation of a multidimensional representation of the image. See, for example, Krizhevsky, et al., “ImageNet classification with deep convolutional neural networks,” NIPS, 2012; Ren, et al., “Faster R-CNN: Towards real-time object detection with region proposal networks,” NIPS, 2015; and Babenko, et al., “Neural codes for image retrieval,” ECCV, 2014 provide examples of such neural networks. Methods for adapting them are described in Babenko, et al., “Aggregating deep convolutional features for image retrieval,” ICCV, 2015 (applies sum-pooling to whitened region descriptors), Kalantidis, et al., “Cross-dimensional weighting for aggregated deep convolutional features,” ECCV Workshop on Web-scale Vision and Social Media, pp. 685-701, 2016 (allows cross-dimensional weighting and aggregation of neural codes). Hybrid models involving an encoding technique such as the Fisher vector (Perronnin, et al., “Fisher vectors meet neural networks: A hybrid classification architecture,” CVPR, 2015), or VLAD (Gong, et al., “Multi-scale orderless pooling of deep convolutional activation features,” ECCV, 2014) can also be employed. Tolias, et al. “Particular object retrieval with integral max-pooling of CNN activations,” ICLR, 2016, describes R-MAC, an approach that produces a global image representation by aggregating the activation features of a CNN in a fixed layout of spatial regions to generate a fixed-length vector representation.

U.S. Pub. Nos. 20030021481; 20070005356; 20070258648; 20080069456; 20080240572; 20080317358; 20090144033; 20090208118; 20100040285; 20100082615; 20100092084; 20100098343; 20100189354; 20100191743; 20100226564; 20100318477; 20110026831; 20110040711; 20110052063; 20110072012; 20110091105; 20110137898; 20110184950; 20120045134; 20120076401; 20120143853, 20120158739, 20160155020, 20160307071, 20170011279 and 20170011280, and U.S. application Ser. No. 14/861,386, filed Sep. 22, 2015, entitled SIMILARITY-BASED DETECTION OF PROMINENT OBJECTS USING DEEP CNN POOLING LAYERS AS FEATURES, by Jose Antonio Rodriguez-Serrano, et al.; U.S. application Ser. No. 14/791,374, filed Jul. 7, 2015, entitled LATENT EMBEDDINGS FOR WORD IMAGES AND THEIR SEMANTICS, by Albert Gordo Soldevila, et al. are also mentioned as examples of methods for generation of image representations, the disclosures of each of which are incorporated herein by reference in their entireties.

In the Examples below, the method described in Gordo Soldevila 2017 is used to generate image representations. This method uses a convolution neural network which receives as input the image as a three-dimensional tensor in which each pixel has a dimension for each color separation, such as R, G, B. The input image may be reduced to a fixed dimensionality prior to processing through the convolutional layers of the neural network. The output of one or more of the convolutional layers (a CNN response map) is used to generate the image representation. In particular, a region proposal network (RPN) is applied to the CNN response map, generating a region vector representing each region of the input image CNN response map. The region vectors representing the regions of the input image CNN response map are sum-aggregated to generate the image representation. As a result, a region of the image can contribute more than others, or differently, to the final image representation. To achieve this, the method of Gordo Soldevila 2017 uses regional maximum activations of convolutions (R-MAC (see, Tolias et al., “Particular Object Retrieval With Max-Pooling of CNN Activations,” ICLR 2016) using the CNN applied to the image. The R-MAC approach is modified by using regions for the R-MAC defined by applying the RPN to the CNN response map. The R-MAC aggregates several image regions into a compact feature vector of fixed length which is therefore robust to scale and translation. The region features are independently l₂-normalized, whitened with PCA and l₂-normalized again before being sum-aggregated.

In the Examples below, the present (“Learned”) method relies solely on the query expansion method described herein. However, it is contemplated that the method may be combined with other forms of query expansion, e.g., recursive AQE, transitive closure expansion, and multiple image resolution expansion, as described, for example, in Chum 2007. In general, however, such methods rely on an accurate geometric verification of the images that are not needed.

The method illustrated in FIGS. 2 and 5 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive or independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2 and/or 5, can be used to implement the query expansion method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The exemplary query expansion method finds application in instance-level image retrieval applications such as in print service, retail and transportation, among others. For print services, retrieving particular logos, images, or stamps (like a confidential stamp) is useful to automate some workflows on scanned documents or emails. For the retail sector, the system may be queried with a single picture of a product that has to be retrieved in store or warehouse shelf images. The ability to retrieve and count specific products in store shelves is useful for detecting out-of-stock products or measuring planogram compliance. In the transportation business, retrieving a particular vehicle or person, based on a single photograph, can useful for example, for surveillance, automated parking fee and toll collection, traffic law enforcement, and the like.

Without intending to limit the scope of the exemplary embodiment, the following Examples illustrate the application of the method to existing datasets.

### EXAMPLES

The datasets, evaluation protocol, and other technical details are first described. Then, the performance of the exemplary method (“Learned”) is compared to other query expansion methods.

Datasets

During the experiments the following different image datasets were used:

1. Oxford 5K: This is a standard retrieval benchmark described in Philbin, et al., “Object retrieval with large vocabularies and fast spatial matching,” CVPR, pp. 1-8, 2007. It contains 5062 images of eleven Oxford sites plus other distractor images. There are 55 query images (5 per site) with an annotated region of interest that is used as a query, and the retrieval performance is measured in mean average precision. On average there are 51 relevant images per query, although 20 of the 55 queries have less than 15 relevant images. This dataset is used exclusively for evaluation purposes: all training is done on the Landmarks dataset.

2. Landmarks: This dataset is described in Babenko, et al., “Neural codes for image retrieval,” ECCV, pp. 584-599, 2014. It contains approximately 214,000 images of 672 famous landmark sites. Its images were collected through textual queries in an image search engine without thorough verification. As a consequence, they include a large variety of profiles: general views of the site, close-ups of details like statues or paintings, with all intermediate cases as well, but also site map pictures, artistic drawings, or even completely unrelated images, which makes it unsuitable for some learning tasks. An automatically cleaned version of this dataset was used, as described in Gordo Soldevila 2017. This subset of the original Landmarks dataset contains approximately 48,000 images of 586 landmarks, and has no overlapping landmarks or images with the Oxford dataset. 42,000 of its images are used as training, and 6000 are used for testing purposes. On average, each image of the training set has 71 other relevant images, while each image of the test set only has 11 other relevant images. However, more than 150 of the training landmarks (out of 586) have less than 20 relevant images, and more than 300 of the testing landmarks dataset have 5 or less. That implies that a high value of K will select some non-relevant items for the query expansion. For testing purposes, all of the 6000 testing images are used in turn as a query to retrieve the relevant items in the remainder of the dataset. As in Oxford, accuracy is measured in terms of mean average precision (Mean AP).

Testing experiments are carried in Oxford 5K and in the test set of the cleaned Landmarks dataset. The training of the query expansion component uses the training images of the clean Landmarks, and the same model 76 is used when evaluating in both datasets.

For generating the image representations 72, 50, a feature learning method is used, as described in Gordo Soldevila 2017, that produces image representations of 512 dimensions. For these representations, similarity can be compared with the dot-product or Euclidean distance. The same method of generating image representations is also used for the comparative methods of query expansion.

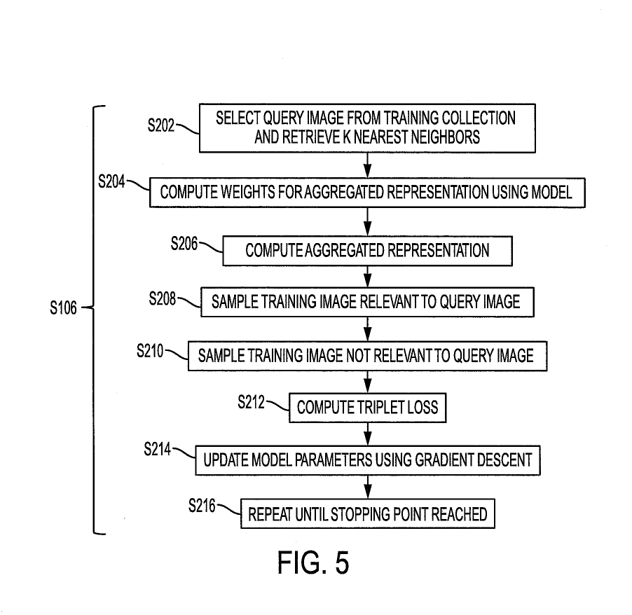

FIG. 6 shows two random queries (left) together with their first 4 retrieved results (right). The weighting of the images should depend not only of the image itself but also of its context. It can be seen that the first retrieved result of the first query also appears as the third result of the second query. When aggregated with the other images of the first query, it should be given a high weight so more images like it are retrieved. However, when aggregated with the images of the second query, it should be given a low (or even negative) weight, so that no more images like it are retrieved. The present method automatically assigns non-uniform weights to the retrieved images using the learned model, which promotes this result.

Experimental results

The exemplary Learned method is evaluated on both testing datasets, varying the values of K and τ. The method is also compared with other query expansion methods, as follows:

1. Average query expansion (AQE): the signatures of the top K results, together with the original query, are averaged.

2. Discriminative query expansion (DQE) with a one-class SVM: at query time, a one class SVM is learned using the top K results as well as the query. The dual coefficients of the SVM are the weights that should be used to aggregate the representations.

3. Discriminative query expansion (DQE) with a two-class SVM: same as the one-class SVM, but one also samples n negative images taken from the middle or bottom of the rank.

The hyperparameters of the DQE baselines (e.g., the C cost parameter of the SVM or the number of negatives samples) are validated directly on the test set, i.e., these methods are given a very considerable advantage.

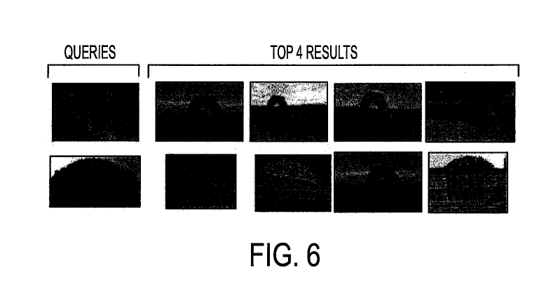

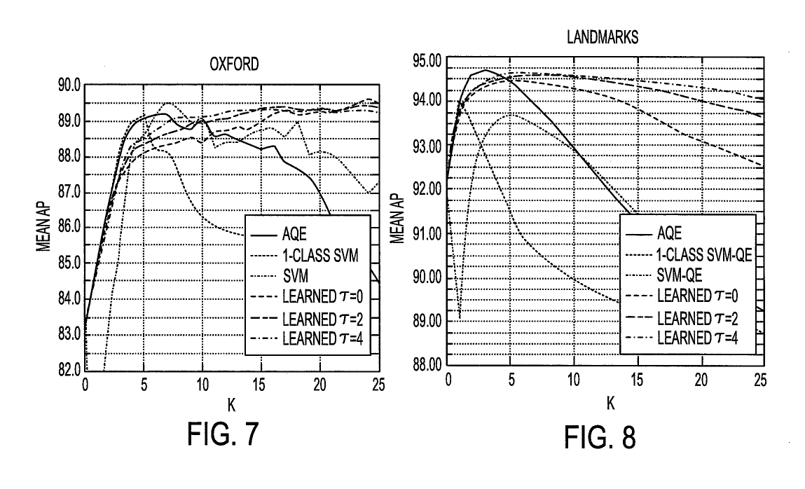

Results are shown in FIGS. 7 and 8 for the Oxford and Landmarks datasets, respectively. The following may be noted.

AQE achieves very good results rapidly. However, it is very sensitive to K. As K increases and more negative/non-discriminative images are aggregated, the results rapidly worsen.

The two SVM-based DQE methods (1-class SVM and SVM) are quite unpredictable. In optimal situations, with several relevant items per image (e.g., in Oxford), they can outperform AQE, but in difficult scenarios (e.g., few relevant items such as in Landmarks) their performance is worse. Since the parameters of the DQE methods were validated directly on the test set, their actual performance is expected to be worse.

The exemplary method (“Learned”) needs a larger K than AQE to achieve the same accuracy. However, as K increases, the Learned method always outperforms AQE, and the best result of the proposed method is equal (Landmarks) or better (Oxford) than the best result of AQE. Choosing a τ value greater than zero to address the bias improves the results, both at the very beginning (both datasets) as well as for higher Ks (Landmarks). A thorough validation of r may lead to better results, but it was found that values in the range 2-4 led to good results.

The exemplary method is much more robust to “overshooting” the value of K. Even choosing K=25, a value larger than the number of relevant items of most queries of both Oxford and Landmarks, the Learned method achieves excellent accuracy in Oxford, and significantly outperforms all other methods in Landmarks.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for query expansion comprising:
receiving a query object representation and a set of representations of similar objects retrieved using the query object representation as a query;
with a processor, predicting weights for the query object representation and the set of similar object representations with a prediction model;
generating an expanded query as a weighted aggregation of the query object representation and at least a plurality of the set of similar object representations in which the query object representation and the least a plurality of the set of similar object representations are each weighted with a respective one of the predicted weights.

2. The method of claim 1, wherein the prediction model generates context-dependent representations based on the query object representation and similar objects representations, the respective weights being a function of the context-dependent representations.

3. The method of claim 1, wherein the prediction model comprises a recurrent neural network.

4. The method of claim 3, wherein the recurrent neural network comprises at least one bi-directional recurrent neural network module.

5. The method of claim 4, wherein the recurrent neural network comprises a stack of at least two bi-directional recurrent neural network modules.

6. The method of claim 4, wherein the at least one bi-directional recurrent neural network module comprises a sequence of Long Short Term Memory (LSTM) or Gated Recurrent Unit (GRU) cells.

7. The method of claim 1, further comprising learning parameters of the prediction model on an annotated training set of object representations.

8. The method of claim 7, wherein the learning of the parameters comprises minimizing a triplet ranking loss over the training set, each triplet comprising an expanded query generated with the model with a representation of query object selected from the training set, a representation of a first object that is relevant to the query object, based on its annotation, and a representation of a second object that is non-relevant to the query object, based on its annotation.

9. The method of claim 8, wherein the learning of the parameters comprises updating the parameters of the prediction model by backpropagating the triplet ranking loss through the prediction model.

10. The method of claim 9, wherein the learning of the parameters further comprises learning parameters of a function which generates the object representations.

11. The method of claim 1, further comprising retrieving the set of representations of similar objects using the query object representation as a query.

12. The method of claim 1, further comprising retrieving a second set of representations of similar objects from a dataset using the expanded query.

13. The method of claim 12, further comprising outputting at least one of the second set of representations of similar objects, the similar objects, and information based thereon.

14. The method of claim 1, wherein the query object comprises an image.

15. The method of claim 1, wherein each of the representations is a multidimensional representation of at least 50 dimensions.

16. A computer program product comprising a non-transitory recording medium storing instructions, which when executed on a computer, causes the computer to perform the method of claim 1.

17. A system comprising memory which stores instructions for performing the method of claim 1 and a processor in communication with the memory which executes the instructions.

18. A system for query expansion comprising:
memory which stores a weights prediction model;
a representation generator which generates a representation of a query object;
a querying component which retrieves a first set of representations of similar objects to the query object using the query object representation as a query;
a query expansion component which predicts weights for the query object representation and the set of similar object representations with the weights prediction model and generates an expanded query as a weighted aggregation of the query object representation and at least a plurality of the set of similar object representations in which the query object representation and the least a plurality of the set of similar object representations are each weighted with a respective one of the predicted weights;
the querying component being configured for retrieving a second set of representations of similar objects based on the expanded query.

19. The system of claim 17, further comprising a learning component which learns the weights prediction model using representations of an annotated set of objects.

20. A method for generating a prediction model for predicting weights for generating an expanded query comprising:
providing an annotated set of training image representations;
with a processor, for a plurality of iterations:
selecting a training image representation as a query image representation,
retrieving a set of similar image representations from the set of training image representations, using the query image representation,
inputting the query image representation and set of similar image representations into a prediction model to be learned,
generating a context-based representation for each of the query image representation and set of similar image representations with a neural network of the prediction model,
with current parameters of a fully-connected layer of the prediction model, converting each of the context-based representations to a respective weight,
generating an expanded query as a sum of the query image representation and similar image representations, each weighted by a respective one of the weights,
computing a loss with a loss function based on the expanded query and representations of first and second training image representations and their respective annotations, and
updating parameters of the prediction model based on the computed loss, the updating including updating the current parameters of the fully-connected layer; and
outputting the prediction model with updated parameters from one of the plurality of iterations.

21. A system comprising memory which stores instructions for performing the method of claim 20 and a processor in communication with the memory which executes the instructions.
